(19) United States
(12) Patent Application Publication
(10) Pub. No.: US 2005/0132978 A1
(43) Pub. Date: Jun. 23, 2005

(54) Livestock squeeze chute and head gate

(76) Inventor: James W. Bentz, Drewsey, OR (US)

Correspondence Address: ROBERT L. SHAVER;DYKAS, SHAVER & NIPPER, LLP, PO BOX 877, BOISE, ID, 83701-0877, US

(21) Appl. No.: 10/745,792

(22) Filed: Dec. 23, 2003

(51) Int. Cl. A01K 15/04

(52) U.S. Cl. 119/732

(57) ABSTRACT

A cattle squeeze chute and head gate that operates with articulated neck bars. Each neck bar is composed of two pieces, which are joined together with a joint or hinge. When the neck bars are pressed upward, they are pulled into a closed position around the neck of an animal. When the neck bars are pressed downward, they spread apart at the joint and release the animal. One side of the chute is hinged from the bottom edge so that the top edge can rotate towards the stationary wall of the chute, capture a cow, and hold it immobile. The head gate includes a control arm, in which hydraulic controls are positioned, which can be positioned by the user for his convenience.

### BACKGROUND OF THE INVENTION

1. Field of the Invention

The present invention generally relates to livestock squeeze chutes and head gates, and more particularly relates to livestock squeeze chutes combined with head gates.

2. Background Information

In a livestock operation, it is sometimes necessary to hold an animal still so that an operation can be performed. This could include treatments done by a veterinarian, examinations of the skin, pest control treatment on the skin and hair, and other typical procedures and treatments. A large animal can weigh more than two thousand (2,000) pounds, and is very strong. Therefore, a chute to immobilize such an animal must be quite sturdy, and be able to lock the animal's head in place securely without injuring it.

One feature which such a device should have, is a closing mechanism that closes on an animal's neck very fast. When an animal is forced to pass through such a chute, they may try to run through to escape out the other end. To stop them from escaping, and to immobilize them within the chute, the sides and the head gate must be able to close very quickly. This will also hold them in the proper position. It is also desirable for such a gate to close in a way that does not frighten the animal. It also needs to close on the animal's neck in a way that is very secure, but does not press so hard on the animal as to cause injury.

A desirable feature of such a chute would be a chute that a person, such as a veterinarian or cattleman, could reach through the side to perform the work on the animal from a position of safety. When one person is performing the work on the animal as well as operating the chute and gate, controls for closing and releasing the gate in the chute need to be easily accessible and positioned for the comfort and ease of the operator.

Another feature that would be desirable in a cattle chute and head gate, is for the hydraulics of the system to be powered by the hydraulic system of a tractor. This source of power is almost always available, even in a small-scale operation. Another feature which is desirable, is a chute and head gate that is reversible so that a user can operate it from either side, depending on the need at the time.

Additional objects, advantages, and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are accomplished by the head gate of the invention. The invention is a livestock squeeze chute, and an associated head gate. The head gate can be sold separately from the chute, or be attached to the chute. The chute includes an entry end frame, an exit end frame, a left and right sidewall which connect the two frames, and a chute floor. The chute floor is attached to the chute frame and is positioned for the livestock to stand on and walk on.

A head gate is preferably attached to the exit end frame, but can be a separate unit. The head gate includes a left and right neck bar. The neck bars have a first end, which is attached to the base of the exit end frame, and a second end, which is attached to the top of the exit end frame. The first end of the neck bars are attached at the base of the exit end frame in a connection that allows them to rotate. The second end of the neck bars attach to the top of the exit end frame in a connection that allows them to move up and down.

Each of the neck bars are made of a lower section and an upper section, which are pivotally joined to each other at a pivot. When the second end of the neck bars are pressed upward, the pivot points of each neck bar are pulled together. This causes the neck bars to close around the neck of an animal. When the connection to the neck bars is pressed downward, the pivot points of the neck bars move away from each other, which cause the neck bars to move apart and release the animal. The invention includes a mechanism for closing the neck bar by raising and lowering the connection of the neck bars to the upper side of the exit end frame. The device also includes sidewalls, with at least one of the sidewalls being configured to rotate toward the second sidewall. This allows the squeeze chute to hold livestock and prevent them from moving through the chute frame.

One configuration of the device is to use a hydraulic cylinder as the closing mechanism for opening and closing the neck bars of the head gate. Hydraulics can also be utilized to move one of the sidewalls in and out. Although hydraulic operation is preferred, it is also possible for the design of the head gate to operate using a mechanically operated device, such as a simple hand lever. Using the hydraulic system of a tractor is a desirable feature of the invention.

One embodiment of the invention includes a tail gate attached to the entry end frame. This would be mounted on the opposite end of the frame as the head gate. Such a tail gate could be articulated in the same way that the head gate is, and could be identical in construction and hydraulically or manually operated, as is the head gate. This configuration allows the head gate to be reversible. The need for reversibility comes, for instance, when a veterinarian may need to access a certain side of a cow. This could be the right or left side. The veterinarian will prefer to access the cow from this side of the squeeze chute that is ridged and non-moveable. This safeguards the veterinarian from the cow forcing the moveable wall out, which could injure the vet. Depending on the side of the cow to be accessed, and whether the vet wants to use it in a left-handed or a right-handed manner, the chute could be positioned so that either the head gate or the tail gate is the end at which the cow enters.

Another possible embodiment is for the first sidewall to by hydraulically operated. In this way, when it is pressed towards the second sidewall, it will hold the livestock immobile. Such a configuration might have the first sidewall hinged at some part or at all of the bottom edge of the sidewall. The top edge would be free to rotate, powered by the hydraulic mechanism. The second sidewall may be rigidly mounted between the two end frames.

Another desirable feature of the livestock chute and head gate of the invention is the use of a control arm, on which are mounted the hydraulic controls. The control arm mounts on a moveable arm so that the controls can be placed in a position favorable to the user. This could mean that the control arm is positioned at a point so that the hydraulic controls are below the heart of the user. This would help the user keep his arms from becoming fatigued because he would not have to reach above his heart to operate the controls. Having the controls in a low position like that is sometimes not desirable. If the head gate is set up in an area where livestock are present, and the controls are set in a low position, the cattle can lean against them, use them to scratch themselves, or press against them by accident and do damage to the controls. In this situation, it would be desirable for the controls to be able to be raised to a high position. It is also desirable for the control arm to be able to move left and right along one of the sidewalls of the chute so that the user can position them at a convenient location for the task he is performing. This becomes especially important when one person is controlling the head gate as well as performing some operation on the livestock. The control arm would also include controls for the head gate, the first sidewall, and the tail gate (if one is present).

Further, the purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measure by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a prospective view of the head gate of the invention.

FIG. 2 is a prospective view of the invention in a closed position.

FIG. 3A is a cross sectional end view of the device showing the controls on alternate sides.

FIG. 3B is a side view of controls in a raised position.

FIG. 4 is a cross sectional end view of the device showing controls on either side. .

FIG. 5 is a top view of the head gate of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

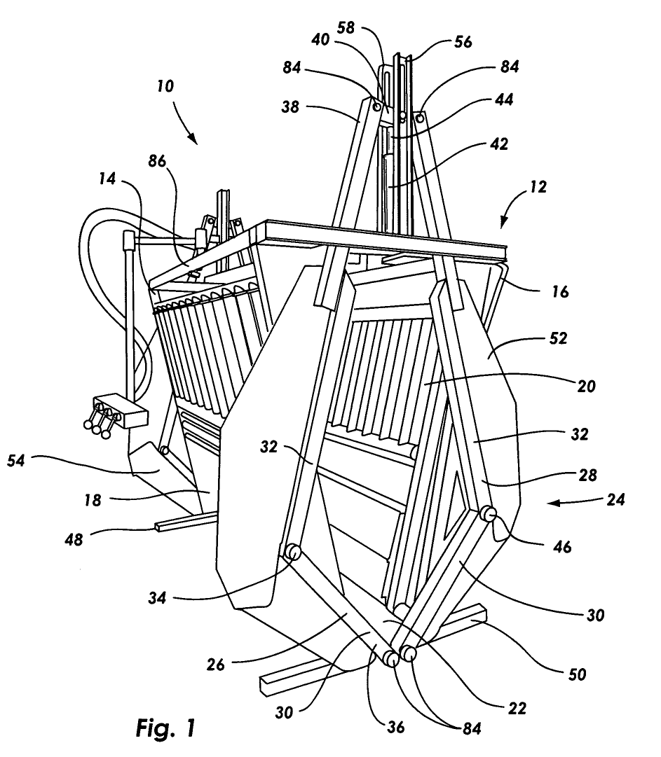

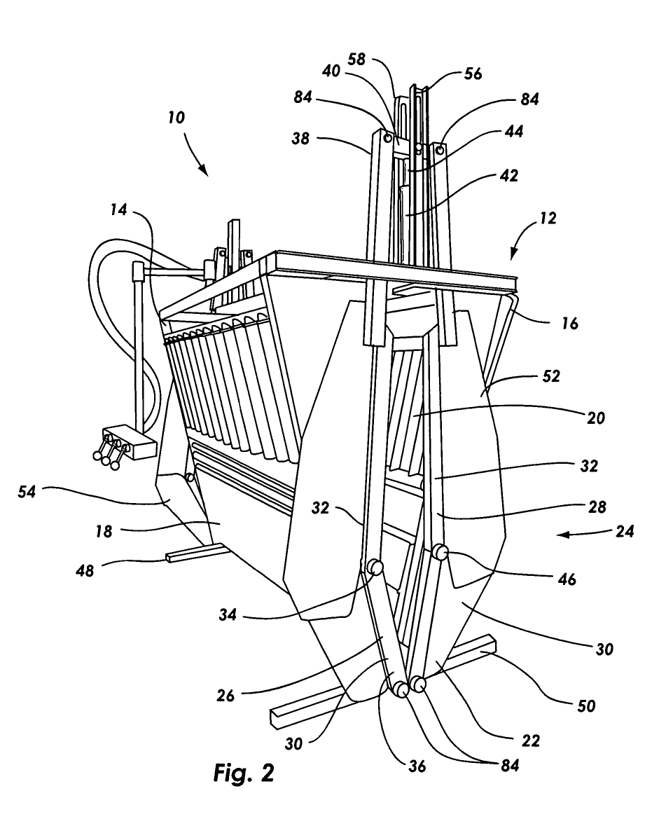

A preferred embodiment of the invention is shown in FIGS. 1-5. FIG. 1 shows the head gate in an open position. The squeeze chute includes a chute frame 12. The chute frame 12 is made up of an entry end frame 14, an exit end frame 16, a first sidewall 18, a second sidewall 20, and a chute floor 22. Attached to the exit end frame 16 is a head gate 24. It includes a left neck bar 26 and a right neck bar 28, with each neck bar made up of a lower section 30 and an upper section 32. The lower section 30 and the upper section 32 are joined together at a joint 34 on the left neck bar, and a corresponding joint 46 on the right neck bar. The left neck bar 26 has a first end 36 and a second end 38. The first end 36 is attached in a moveable hinge configuration 82 to the chute frame 12. The second end 38 of the left neck bar is attached to a bracket 40 and is also able to rotate around a connection 84. The right neck bar 28 is similarly configured, it is also attached to the bracket 40. The bracket 40 is held in a frame in which it may slide up and down. Below the bracket 40 is a hydraulic cylinder 42, from which extends a hydraulic piston 44. The neck bars are configured so that when the hydraulic piston 44 presses upward and pushes bracket 40 away from the chute frame 12, the left neck bar 26 and the right neck bar 28 are also pushed upward. This causes the joint 34 to move towards the joint 46. As the bracket 40 continues to be raised, the head gate 24 moves to the configuration shown in FIG. 2, which is the closed position.

The frame includes an entry end base 48 and an exit end base 50.

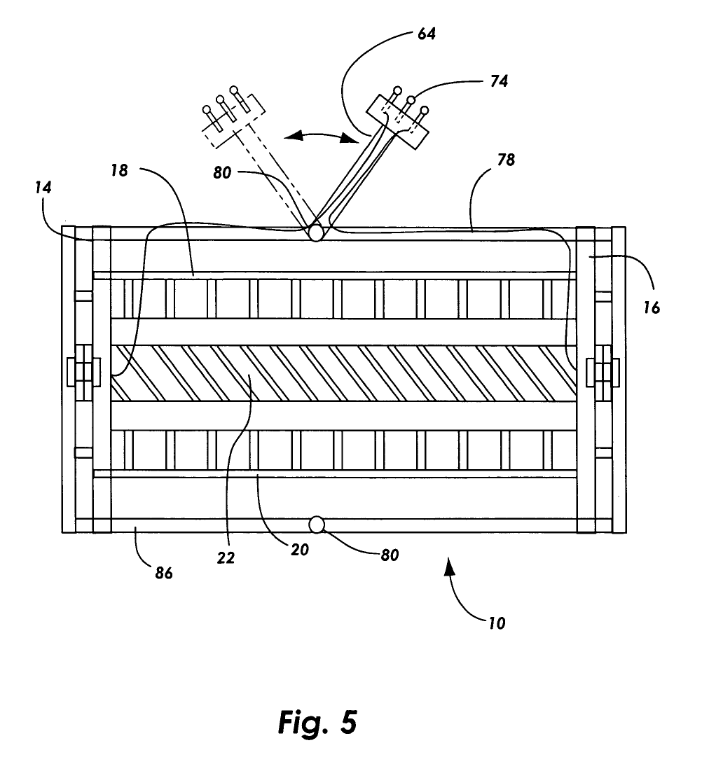

The general design of the livestock head gate can be modified according to the particular type of livestock it is being utilized with. The design shown is generally configured for working with cattle. Other designs, which are sized for other types of livestock, could also be used. In the design shown, the end frames 14 and 16 are generally formed in the shape of a trapezoid, with the base portion extending out from the bottom of the trapezoid. The top of the trapezoid is larger than the bottom. In the preferred embodiment for use with cattle, the end frames are made of 3 in by ¼ inch square steel tubing. Other sizes of tubing, round tubing, bar stock, angle iron or other materials could also be utilized. Other elements of the chute frame 12 include the bases 48 and 50, which are preferably 3 in by ¼ inch square steel tubing. The floor 22, shown in FIG. 5, is preferably ⅜ inch thick steel plate. The first sidewall 18 and the second sidewall 20 can take a number of configurations, but having a solid lower and upper wall with tubular bars works well. In this configuration, the tubular bars are 2.5 inch in diameter, 3/16 thick, and hinged at their lower end. The lower part of the sidewalls are made of ⅛-inch thick sheet metal, and also are hinged at the bottom to allow access to the interior of the chute.

The chute floor 22 is attached to the chute frame 12. The chute floor 22 being attached to the chute frame 12 is important because by having the animal stand on the chute floor 22, the animal's weight adds to the stability of the cattle squeeze chute 10. If a heavy and strong animal were to stand on the ground between the sidewalls, the animal could tip the squeeze chute over, cause it to move, or pick it up and carry it.

The entry end frame 14 and the exit end frame 16 are connected to each other by steel frame members 86, which are preferably 3 in by ¼ inch angle iron.

Attached to the lower sections 30 and upper sections 32 are side shields 52. These are preferably ⅛ inch thick steel. They are present to close any openings in the head gate 24, preventing an animal from accidentally extending any body part past the left neck bar 26 or right neck bar 28.

As shown in the drawings, one preferred embodiment of the device utilizes a tail gate 54, which is attached to the entry end frame 14, and can be identical to the head gate 24.

The head gate 24 includes risers 56 and 58, which are attached to the top of the exit frame 16. The risers 56 and 58 surround the hydraulic cylinder 42 and encloses the bracket 40 in slideable engagement. Bracket 40 is free to move between riser 56 and riser 58.

Joint 34 and joint 46 are preferably 3 inch knuckle joints. These joints are formed of a flat section, attached to a tubular section. Two such pieces are put together, with the tubular sections aligned so a pin can go through them. Connection points 84 are preferably formed by a pin, which passes through the second end of the neck bar 38 and the bracket 40. This pin can be held in place by welding, with split rings, nuts, bolts, or other common fasteners. The lower section 30 pieces are attached to the exit end base 50 using a connection 82 that allows the lower sections 30 to rotate. This is preferably a sleeve and pin configuration, but obviously other means of mechanically connecting these pieces could be utilized.

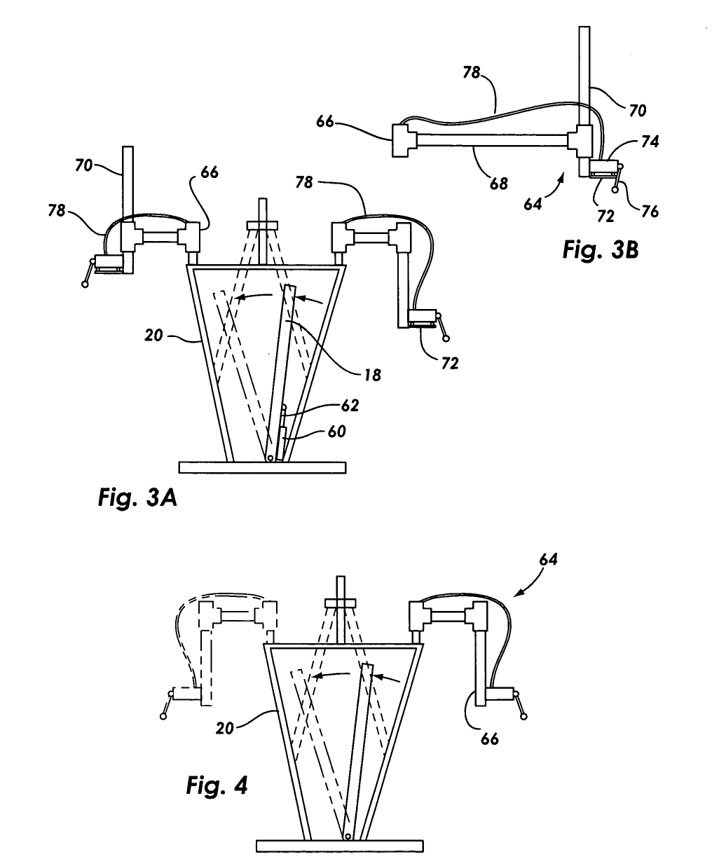

FIG. 3A shows a cross sectional view of the squeeze chute, with the first sidewall 18 in an opened position. Also shown, is sidewall hydraulic cylinder 60 and hydraulic piston 62. This drawing also shows second sidewall 20, which is preferably immoveable and rigidly attached to the chute frame 12. FIG. 3B show the controls in a raised position.

FIG. 3A and FIG. 4 show that first sidewall 18 can move from an open position to a closed position. This movement is caused by the hydraulic cylinder 60 being activated to push the hydraulic cylinder 62 out. As hydraulic cylinder 62 extends, the first sidewall 18 is pressed towards the second sidewall 20.

Also shown in FIG. 3, is the hydraulic control arm 64. The hydraulic control arm includes a frame coupling 66, an arm 68, a tube 70, and a control platform 72. Mounted on the control platform 72 are the hydraulic controls 74. The hydraulic controls 74 include control levers 76 and hydraulic hoses 78. The hydraulic hoses 78 go from the hydraulic controls 74 to the hydraulic cylinders used in the device. This can include one or more hydraulic cylinders on the head gate and tail gate, and one or more hydraulic cylinders on the first sidewall 18. The frame coupling 66 attaches to the frame at attachment stub 78. Preferably, there is an attachment stub 78 on both sides of the squeeze chute 10. This would allow the hydraulic control arm 64 to be dismounted from one side, carried to the other side, and remounted on the other side. FIG. 3 shows the hydraulic control arm 64 mounted on the left side of the chute frame 12, and the tube 70 moved to a raised position. It also shows that the hydraulic control arm 64 can be mounted on the right side, and the tube 70 moved to a lowered position.

FIG. 4 shows the hydraulic control arm 64 mounted on the right side of the chute frame 12 and the tube 70 moved to a lowered position. The lower position would be preferable for ease of operation for the user. In this position the controls are available to the user at a height that is easy to reach and reduces fatigue to a user. However, this position is undesirable when cattle are in the area, such as when the device is stored in a corral. In such a case, the tube 70 can be moved to the raised position shown in FIG. 3, so that it is up and out of the way and not likely to be damaged by nearby cattle.

An important feature of the hydraulic system is that it can be powered by a hydraulic system of a tractor. Even small operations usually have a tractor nearby, and the hydraulic connection to a tractor is simple.

One feature of the cattle head gate that is important is that the mechanical structure of the head gate, powered by a hydraulic cylinder, causes the head gate to move from a closed position to an opened position very rapidly. A skilled operator can close the head gate while simultaneously moving the first sidewall 18 to a closed position. A further advantage of this design is that as the head gate begins to close, the closing is not particularly apparent to a cow. It does not react as if it is being trapped, as cows tend to do with other types of head gates. This may be because there is less gross movement from the neck bars since they are fixed at the ends and articulated in the center.

The preferred embodiment of the cattle head gate of the invention utilizes a tail gate 54 on the opposite end from the head gate 24. This allows the unit to be completely reversible. The preferred side for a veterinarian to work from is behind the second sidewall 20. This is because that sidewall is stationary, and the veterinarian can stand behind it in safety. Depending on the operation to be preformed, the cattle head gate 10 of the invention may preferably have the second sidewall 20 on the animals left or right side. With a head gate and a tail gate, this reversing option is available.

FIG. 5 is a top view of the cattle head gate of the invention. It shows the first sidewall 18, the second sidewall 20, the floor 22, the entry end frame 14, the exit end frame 16, the hydraulic control arm 64, the control levers 74, and the hydraulic lines 78. This view shows that the control arm 64, in addition to being able to be raised up and down as shown in FIGS. 3 and 4, can also move out laterally, pivoting on the frame coupling 66 and the attachment stub 80. As shown in FIG. 5, there is an attachment stub 80 on both sides of the frame 12, and the control arm 64 can be moved to either side as preferred by the user.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A livestock head gate for use with a cattle chute, comprising:
a head gate frame, configured for attachment to a cattle chute, said head gate comprised of a left neck bar, and a right neck bar, with said neck bars attached at a first end to a head gate frame base, and slideably attached at a second end to a head gate frame top piece, with each respective neck bar comprised of a lower section and an upper section, which are pivotally joined to each other at a right and left pivot, with said head gate configured to close when said second ends of said neck bars are pressed upward, which causes said pivot points to be pulled together, and configured to open when said second ends of said neck bars are pressed downward from a closed position, which causes said pivot points to be pressed apart;
a neck bar closing mechanism, which closes said neck bars by raising said connection of said neck bars to said head gate frame top piece, and opens said neck bars by lowering said connection of said neck bars to said head gate frame top piece; and

2. The livestock head gate of claim 1 which further includes an attached cattle chute, comprising:
a chute frame, with an entry end frame, an exit end frame, a left and right sidewall connecting said end frames;
a chute floor, attached to said chute frame, and positioned for livestock to stand and walk on; and
at least a first of said sidewalls configured to rotate toward a second of said sidewall, thereby squeezing and holding a livestock from progressing through the chute frame.

3. The livestock head gate apparatus of claim 2 in which said neck bar closing mechanism is a hydraulic cylinder which pushes said neck bars upward from said exit end frame.

4. The livestock head gate apparatus of claim 2 which further includes an articulated tail gate attached to said entry end frame.

5. The livestock head gate apparatus of claim 4 in which said tail gate and said head gate are identical in construction and are both hydraulically operated.

6. The livestock head gate apparatus of claim 5 in which said first sidewall is hydraulically operated, and holds livestock immobile when said first sidewall is moved toward said second sidewall.

7. The livestock head gate apparatus of claim 6 in which said first sidewall is hinged at the bottom edge, and the top edge is free to move around said hinge.

8. The livestock head gate of claim 5, in which said second sidewall is rigidly mounted between said end frames.

9. The livestock head gate of claim 5, which is reversible so that either end may be positioned for entry and exit of livestock.

10. The livestock head gate of claim 3 which includes a user positionable control arm, on which hydraulic controls for controlling said hydraulic cylinder which opens and closes said neck bars.

11. The livestock head gate of claim 6 which includes a user positionable control arm, on which hydraulic controls for controlling said hydraulic cylinder which opens and closes said neck bars of said head gate and said tail gate, and controls for said sidewall may be mounted.

12. The livestock head gate of claim 11 in which said control arm may be moved to the left of right, and up or down, as the user prefers, for optimum operation of said squeeze chute and head gate.

13. The livestock head gate of claim 12 in which said control arm is positionable on either said first sidewall, or on said second sidewall, and may be moved to the position preferred by the user.

14. The livestock head gate of claim 3 in which said hydraulic power is supplied by a hydraulic system of a tractor.

15. A livestock head gate, comprising:
a chute frame, with an entry end frame, an exit end frame, a first and a second sidewall connecting said end frames;
in which said first sidewall is hydraulically operated and configured for rotation from a hinged bottom edge, and holds livestock immobile when said first sidewall is moved toward said second sidewall.
a chute floor, attached to said chute frame, and positioned for livestock to stand and walk on;
a head gate attached to said exit end frame, comprised of a left neck bar, and a right neck bar, with said neck bars attached at a first end to said exit end frame, and slideably attached at a second end to said exit end frame, with each respective neck bar comprised of a lower section and an upper section, which are pivotally joined to each other at a right and left pivot, with said head gate configured to close when said second ends of said neck bars are pressed upward, which causes said pivot points to be pulled together, and configured to open when said second ends of said neck bars are pressed downward from a closed position, which causes said pivot points to be pressed apart;
a neck bar closing mechanism comprising a hydraulic cylinder which pushes said neck bars upward from said exit end frame, which closes said neck bars by raising said connection of said neck bars to said exit end frame, and opens said neck bars by lowering said connection of said neck bars to said exit end frame;
a tail gate identical to said head gate, with a second neck bar closing mechanism; and
at least a first of said sidewalls configured to rotate toward a second of said sidewall, thereby squeezing and holding a livestock from progressing through the chute frame.

16. A livestock squeeze chute, comprising:
a chute frame, with an entry end frame, an exit end frame, a first and a second sidewall connecting said end frames;
in which said first sidewall is hydraulically operated and configured for rotation from a hinged bottom edge, and holds livestock immobile when said first sidewall is moved toward said second sidewall.
a chute floor, attached to said chute frame, and positioned for livestock to stand and walk on; and
at least a first of said sidewalls configured to rotate toward a second of said sidewall, thereby squeezing and holding a livestock from progressing through the chute frame.

17. The livestock head gate of claim 15 in which said first sidewall is powered by a hydraulic system of a tractor.
